(19) United States
(12) Patent Application Publication
(10) Pub. No.: US 2006/0091937 A1
(43) Pub. Date: May 4, 2006

(54) Internal voltage generator

(75) Inventor: Chang-Ho Do, Ichon-shi (KR)

Correspondence Address: MCDERMOTT WILL & EMERY LLP, 600 13TH STREET, N.W., WASHINGTON, DC, 20005-3096, US

(73) Assignee: HYNIX SEMICONDUCTOR INC.

(21) Appl. No.: 11/119,940

(22) Filed: May 3, 2005

(30) Foreign Application Priority Data
Nov. 4, 2004 (KR) 2004-89326

(51) Int. Cl. G05F 1/10

(52) U.S. Cl. 327/538

(57) ABSTRACT

An internal voltage generator for use in a semiconductor memory device includes an internal voltage generation unit for generating the internal voltage according to a standby power mode and an active power mode based on a result of comparing the internal voltage with a first reference voltage; and an internal voltage pull-down unit for controlling a voltage level of the internal voltage based on a result of comparing the internal voltage with a second reference voltage.

### FIELD OF INVENTION

The present invention relates to an internal voltage generator for use in a semiconductor device; and, more particularly, to an internal voltage generator for stably generating an internal voltage.

### DESCRIPTION OF PRIOR ART

An internal voltage generator for use in a semiconductor memory device generates internal voltages having various voltage levels to be used in the semiconductor memory device by using a power supply voltage VDD. The internal voltage can be generated according to different power modes, i.e., a standby mode and an active mode. At the standby mode, the semiconductor memory device is in a state of waiting for an external command for performing a corresponding operation. During the standby mode, the internal voltage is generated by a normal driver. When the external command is inputted to the semiconductor memory device, the power mode is changed to the active mode, and the corresponding operation is performed by the semiconductor memory device. Accordingly, a power consumption is increased and, thus, a voltage level of the internal voltage is decreased. Therefore, during the active mode, an active mode driver as well as the normal driver is operated in order to increase a driving strength for generating the internal voltage.

FIG. 1 is a block diagram showing a conventional internal voltage generator for use in a semiconductor memory device.

As shown, the conventional internal voltage generator includes a normal driving unit 10 for generating an internal voltage VCORE based on a result of comparing a reference voltage VR with the internal voltage VCORE; an active mode driving unit 20 for controlling a voltage level of the internal voltage VCORE at an active mode; and a driving control unit 30 for controlling the active mode driving unit 20.

The normal driving unit 10 includes a normal level detection unit 12 and a normal driver PM1.

The normal level detection unit 12 compares the reference voltage VR with the internal voltage VCORE to thereby generate a normal driving control signal drv_onb0 based on the comparison result. The normal driver PM1 generates the internal voltage VCORE according to the normal driving control signal drv_onb0.

The active mode driving unit 20 includes an active level detection unit 22, a driving time control unit 24, a first active mode driver PM2 and a second active mode driver PM3.

The active level detection unit 22 compares the reference voltage VR with the internal voltage VCORE in response to an active mode control signal ratv to thereby generate a first active driving control signal drv_onb1. The first active mode driver PM2 controls the voltage level of the internal voltage VCORE according to the first active driving control signal drv_onb1. The driving time control unit 24 generates a second active driving control signal ovd_onb in response to the active mode control signal to thereby control the second active mode driver PM3.

The driving control unit 30 generates the active mode control signal ratv according to an active command ACT and a precharge command PCG.

Meanwhile, a loading circuit 40 is a circuit which is supplied with the internal voltage VCORE. An internal current I_{VCORE} is a current consumed by the loading circuit 40.

FIG. 2 is a timing diagram showing operations of the conventional internal voltage generator shown in FIG. 1.

Referring to FIGS. 1 and 2, the operations of the conventional internal voltage generator are described below.

The normal driving unit 10 is operated both at the standby mode and the active mode. When the internal voltage VCORE is lower than the reference voltage VR, the normal level detection unit 12 activates the normal driving control signal drv_onb0 to thereby turn on the normal driver PM1, and thus, the voltage level of the internal voltage VCORE is increased. On the contrary, when the internal voltage VCORE is higher than the reference voltage VR, the normal level detection unit 12 inactivates the normal driving control signal drv_onb0 to thereby turn off the normal driver PM1 for decreasing the voltage level of the internal voltage VCORE.

Meanwhile, when the active command signal ACT and a row address are inputted to the semiconductor memory device, data stored in a plurality of memory cells are sensed and amplified. Therefore, a consumption of the internal current I_{VCORE} is rapidly increased and the voltage level of the internal voltage VCORE is rapidly decreased.

At this time, the driving control unit 30 activates the active mode control signal ratv in response to the active command ACT. Then, in response to the active mode control signal ratv, the active level detection unit 22 and the driving time control unit 24 are enabled. Since the internal voltage VCORE is lower than the reference voltage VR, the active level detection unit 22 activates the first active driving control signal drv_onb1. Therefore, the first active mode driver PM2 is turned on to thereby increase the voltage level of the internal voltage VCORE.

Meanwhile, the driving timing control unit 24 activates the second active driving control signal ovd_onb in response to the active mode control signal ratv. Accordingly, the second active mode driver PM3 is turned on while the second active driving control signal ovd_onb is activated. Herein, the second active driving control signal ovd_onb is activated for a predetermined time (a).

Therefore, since the first and the second active drivers PM2 and PM3 as well as the normal driver PM1 are operated, the voltage level of the internal voltage VCORE is increased to a voltage level of the reference voltage VR.

Thereafter, while the active mode control signal ratv is activated, the normal level detection unit 12 and the active level detection unit 22 control the normal driver PM1 and the first active mode driver PM2 to thereby keep the voltage level of the internal voltage VCORE based on the result of comparing between the internal voltage VCORE and the reference voltage VR.

Thereafter, when the precharge command PCG is inputted to the semiconductor memory device, the driving control unit 30 inactivates the active mode control signal ratv. Therefore, the active level detection unit 20 is disabled. Accordingly, while the active mode control signal ratv is inactivated, only the normal level detection unit 12 is activated for controlling the internal voltage VCORE.

As described above, the normal driving unit 10 is operated to control the internal voltage VCORE both at the standby mode and the active mode. However, since the internal voltage VCORE is rapidly decreased at the active mode, the active mode driving unit 20 is additionally operated to control the internal voltage VCORE.

Herein, since the internal voltage VCORE is most rapidly decreased right after the active command ACT is inputted to the semiconductor memory device, the second active mode driver PM3 is turned on for the predetermined time a in addition to the normal driver PM1 and the first active mode driver PM2. That is, the driving time control unit 24 activates the second active driving control signal ovd_onb for the predetermined time α after the active mode control signal ratv is activated.

Meanwhile, it takes a turn on response time tA for the active level detection unit 22 to turn on the first active mode driver PM2 after detecting the voltage level of the internal voltage VCORE is lower than the reference voltage VR. Similarly, it takes a turn off response time tB for the active level detection unit 22 to turn off the first active mode driver PM2 after detecting the voltage level of the internal voltage VCORE is higher than the reference voltage VR.

Therefore, even if the internal voltage VCORE becomes higher than the reference voltage VR, the first active mode driver PM2 is activated for the turn off response time tB after the internal voltage VCORE becomes higher than the reference voltage VR. Accordingly, the internal voltage VCORE becomes too much higher than the reference voltage VR by a voltage level of ΔV.

As a result, since an internal voltage is too much higher than a reference voltage, various circuits supplied with the internal voltage may not be stably operated. In addition, during a burn-in test in which a power supply voltage is increased for testing a semiconductor memory device, an internal voltage is more increased, and thus, the various circuits supplied with the internal voltage may be physically damaged.

### SUMMARY OF INVENTION

It is, therefore, an object of the present invention to provide an internal voltage generator capable of stably maintaining a voltage level of an internal voltage.

In accordance with an aspect of the present invention, there is provided an internal voltage generator for use in a semiconductor memory device, including: an internal voltage generation unit for generating the internal voltage according to a standby power mode and an active power mode based on a result of comparing the internal voltage with a first reference voltage; and an internal voltage pull-down unit for controlling a voltage level of the internal voltage based on a result of comparing the internal voltage with a second reference voltage.

In accordance with another aspect of the present invention, there is provided an internal voltage generator for use in a semiconductor memory device, including: an internal voltage generation unit for generating the internal voltage according to a standby power mode and an active power mode based on a result of comparing the internal voltage with a first reference voltage; an internal voltage pull-down unit for controlling a voltage level of the internal voltage based on a result of comparing the internal voltage with a second reference voltage; and a pull-down control unit for adjusting a voltage level of the second reference voltage and for enabling/disabling the internal voltage pull-down unit according to the standby power mode and the active power mode.

### BRIEF DESCRIPTION OF THE DRAWINGS

The above and other objects and features of the present invention will become apparent from the following description of preferred embodiments taken in conjunction with the accompanying drawings, in which:

FIG. 1 is a block diagram showing a conventional internal voltage generator for use in a semiconductor memory device;

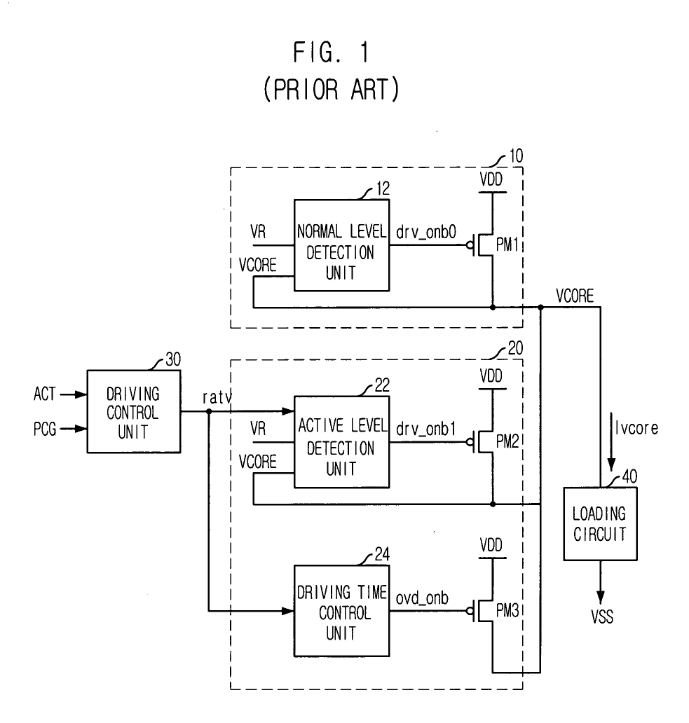

FIG. 2 is a timing diagram showing operations of the conventional internal voltage generator shown in FIG. 1;

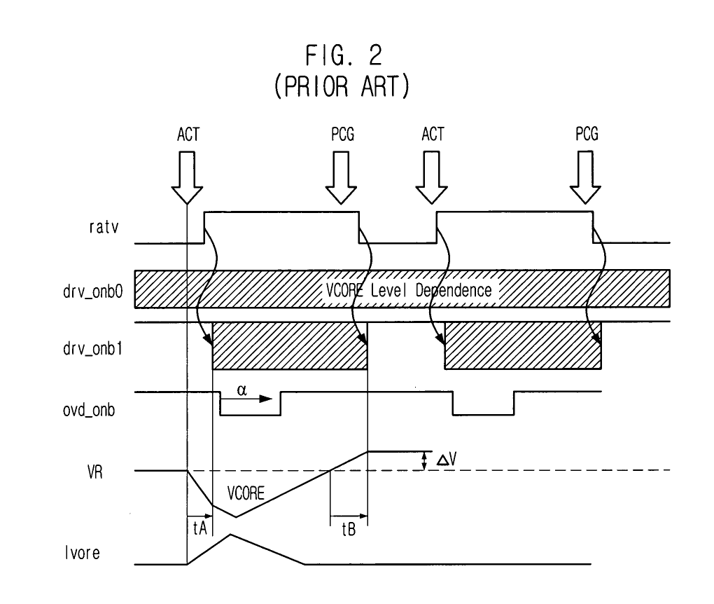

FIG. 3 is a block diagram showing an internal voltage generator in accordance with a first embodiment of the present invention;

FIG. 4 is a timing diagram showing an operation of the internal voltage generator shown in FIG. 3; and

FIG. 5 is a block diagram showing an internal voltage generator in accordance with a second embodiment of the present invention.

### DETAILED DESCRIPTION OF INVENTION

Hereinafter, an internal voltage generator in accordance with the present invention will be described in detail referring to the accompanying drawings.

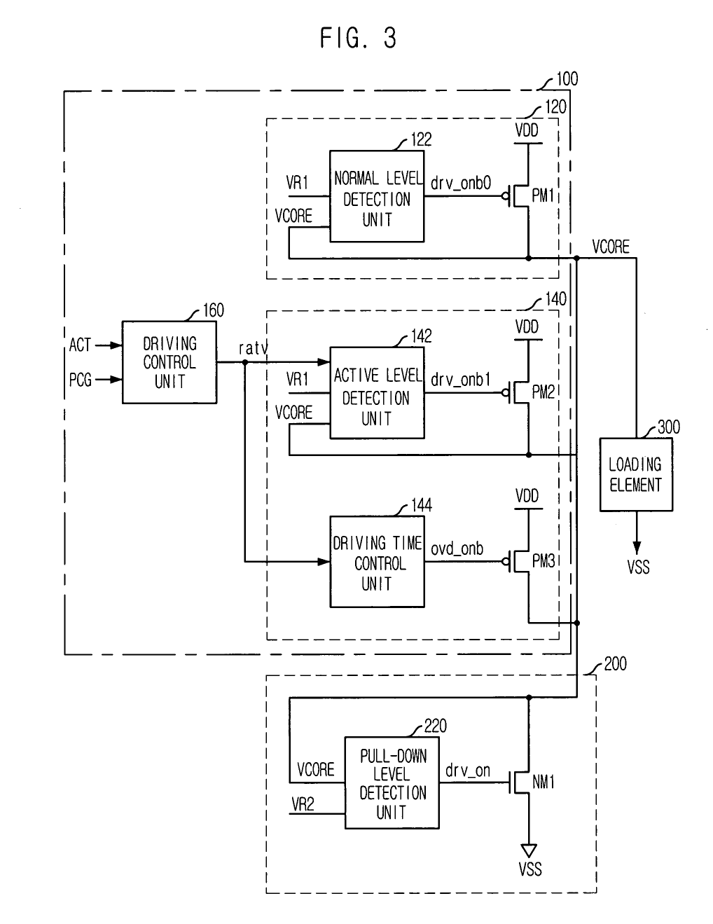

FIG. 3 is a block diagram showing an internal voltage generator in accordance with a first embodiment of the present invention.

As shown, the internal voltage generator includes an internal voltage generation unit 100 for generating an internal voltage VCORE according to a standby mode and an active mode to thereby control the internal voltage VCORE to be equal to or greater than a first reference voltage VR1; and an internal voltage pull-down unit 200 for pulling down a voltage level of the internal voltage VCORE to thereby control the internal voltage VR2 not to be greater than a second reference voltage VR2. Herein, a voltage level of the second reference voltage VR2 is equal to or higher than a voltage level of the first reference voltage VR1.

Meanwhile, a loading circuit 300 is a circuit which is supplied with the internal voltage VCORE.

A structure and an operation of the internal voltage generation unit 100 are similar to those of the conventional internal voltage generator.

The internal voltage generator includes a normal driving unit 120 for generating the internal voltage VCORE based on a result of comparing the first reference voltage VR1 with the internal voltage VCORE; an active mode driving unit 140 for controlling the voltage level of the internal voltage VCORE at the active mode; and a driving control unit 160 for controlling the active mode driving unit 20 based on an active command ACT and a precharge command PCG.

The normal driving unit 120 includes a normal level detection unit 122 and a normal driver PM1.

The normal level detection unit 122 compares the first reference voltage VR1 with the internal voltage VCORE to thereby generate a normal driving control signal drv_onb0 based on the comparison result. The normal driver PM1 controls the voltage level of the internal voltage VCORE according to the normal driving control signal drv_onb0. Herein, normal level detection unit 122 is a differential amplifier receiving the first reference signal VR1 and the internal voltage VCORE as input signals. The normal driver PM1 is a voltage level down converter embodied with a p-type metal oxide semiconductor (PMOS) transistor for down converting a power supply voltage VDD.

The active mode driving unit 140 includes an active level detection unit 142, a driving time control unit 144, a first active mode driver PM2 and a second active mode driver PM3.

The active level detection unit 142 compares the first reference voltage VR1 with the internal voltage VCORE in response to an active mode control signal ratv to thereby generate a first active driving control signal drv_onb1. The first active mode driver PM2 controls the voltage level of the internal voltage VCORE according to the first active driving control signal drv_onb1. The driving time control unit 144 generates a second active driving control signal ovd_onb in response to the active mode control signal to thereby control the second active mode driver PM3. Herein, the active level detection unit 142 is a differential amplifier receiving the first reference signal VR1 and the internal voltage VCORE as input signals. Each of the first and the second active mode drivers PM2 and PM3 is a voltage level down converter embodied with a PMOS transistor for down converting the power supply voltage VDD.

The driving control unit 160 generates the active mode control signal ratv based on the active command ACT and the precharge command PCG.

The internal voltage pull-down unit 200 includes a pull-down level detection unit 220 and a pull-down driver NM1.

The pull-down level detection unit 220 compares the second reference voltage VR2 with the internal voltage VCORE to thereby generate a pull-down control signal drv_on according to a result of the comparison. The pull-down driver NM1 decreases the voltage level of the internal voltage VCORE in response to the pull-down control signal drv_on. When the internal voltage VCORE is higher than the second reference voltage VR2, the pull-down level detection unit 220 activates the pull-down control signal drv_on. Then, the pull-down driver NM1 is turned on in response to the pull-down control signal drv_on to thereby decrease the voltage level of the internal voltage VCORE. Herein, the pull-down level detection unit 220 can be embodied with a differential amplifier. The pull-down driver NM1 can be embodied with an n-type metal oxide (NMOS) transistor.

As above-mentioned, if the voltage level of the internal voltage VCORE becomes higher than the second reference voltage VR2, the internal voltage pull-down unit 200 decreases the voltage level of the internal voltage VCORE. Therefore, the internal voltage generator can prevent the internal voltage VCORE from being too much increased.

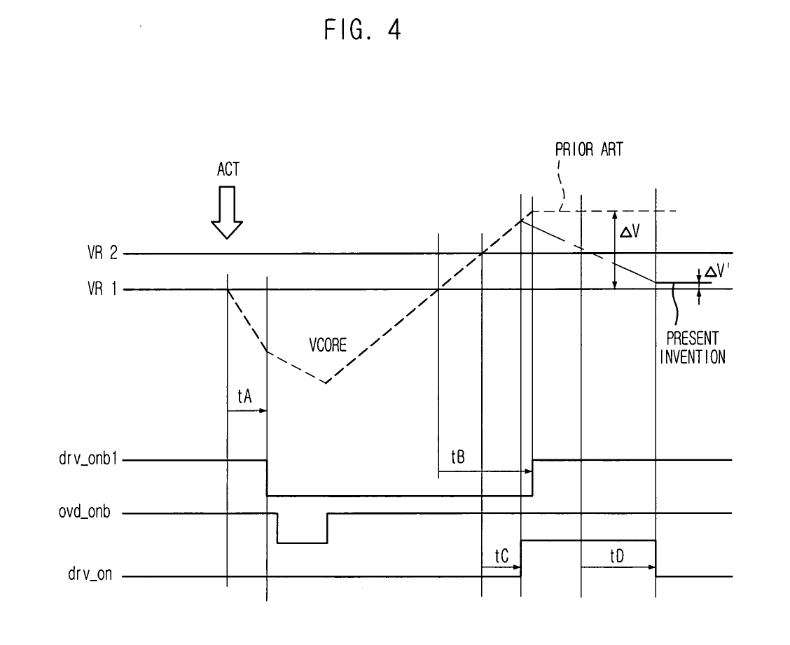

FIG. 4 is a timing diagram showing an operation of the internal voltage generator shown in FIG. 3.

Referring to FIGS. 3 and 4, the operation of the internal voltage generator is described below.

The normal driving unit 120 is operated both at the standby mode and the active mode. When the internal voltage VCORE is lower than the first reference voltage VR1, the normal level detection unit 122 activates the normal driving control signal drv_onb0 to thereby turn on the normal driver PM1, and thus, the voltage level of the internal voltage VCORE is increased. On the contrary, when the internal voltage VCORE is higher than the first reference voltage VR1, the normal level detection unit 122 inactivates the normal driving control signal drv_onb0 to thereby turn off the normal driver PM1.

Meanwhile, when the active command signal ACT is inputted to a semiconductor memory device and the semiconductor memory device performs a corresponding operation, the voltage level of the internal voltage VCORE is rapidly decreased and becomes lower than the first reference voltage VR1.

At this time, the driving control unit 160 activates the active mode control signal ratv in response to the active command ACT. Then, in response to the active mode control signal ratv, the active level detection unit 142 and the driving time control unit 144 are enabled. Since the internal voltage VCORE is lower than the first reference voltage VR1, the active level detection unit 142 activates the first active driving control signal drv_onb1. Therefore, the first active mode driver PM2 is turned on to thereby increase the voltage level of the internal voltage VCORE.

Meanwhile, the driving timing control unit 144 activates the second active driving control signal ovd_onb in response to the active mode control signal ratv. Accordingly, the second active mode driver PM3 is turned on while the second active driving control signal ovd_onb is activated. Herein, the second active driving control signal ovd_onb becomes inactivated after a predetermined time is passed after the second active driving control signal ovd_onb is activated.

Meanwhile, it takes a first turn on response time tA for the active level detection unit 142 to activate the first active driving control signal drv_onb1 after detecting the voltage level of the internal voltage VCORE is lower than the first reference voltage VR1. Accordingly, during the first turn on response time tA, a decreasing speed of the internal voltage VCORE is not reduced. After the first turn on response time tA is passed, the first active driving control signal drv_onb1 is activated. The second active driving control signal ovd_onb is also activated for the predetermined time. Therefore, a decreasing speed of the internal voltage VCORE is reduced and begins to be increased.

Thereafter, when the voltage level of the internal voltage VCORE is higher than the first reference voltage VR1, the active level detection unit 142 turns off the first active mode driver PM2. However, since it takes a first turn off response time tB for the active level detection unit 142 to turn off the first active mode driver PM2, the internal voltage VCORE is increased and becomes higher than the second reference voltage VR2 during the first turn off response time tB.

The pull-down level detection unit 220 activates the pull-down control signal drv_on to thereby turn on the pull-down driver NM1 after detecting the internal voltage VCORE is higher than the second reference voltage VR2. However, since it takes a second turn on response time tC for the pull-down level detection unit 220 to turn on the pull-down driver NM1, the internal voltage VCORE is increased for the second turn on response time tC after the internal voltage VCORE becomes higher than the second reference voltage VR2. After the second turn on response time tC is passed, the pull-down driver NM1 is turned on, and thus, the internal voltage VCORE is decreased.

Thereafter, when the internal voltage VCORE is lower than the second reference voltage VR2, the pull-down level detection unit 220 turns off the pull-down driver NM1. However, since it takes a second turn off response time tD for the pull-down level detection unit 220 to turn off the pull-down driver NM1, the internal voltage VCORE is decreased for the second turn off response time tD.

Accordingly, in comparison with the conventional internal voltage generator, the internal voltage generator in accordance with the first embodiment of the present invention can prevent the internal voltage VCORE from being too much increased. As shown in FIG. 4, a voltage increase from the first reference voltage VR1 of the present invention (ΔV′) is much smaller than that of the prior art (ΔV).

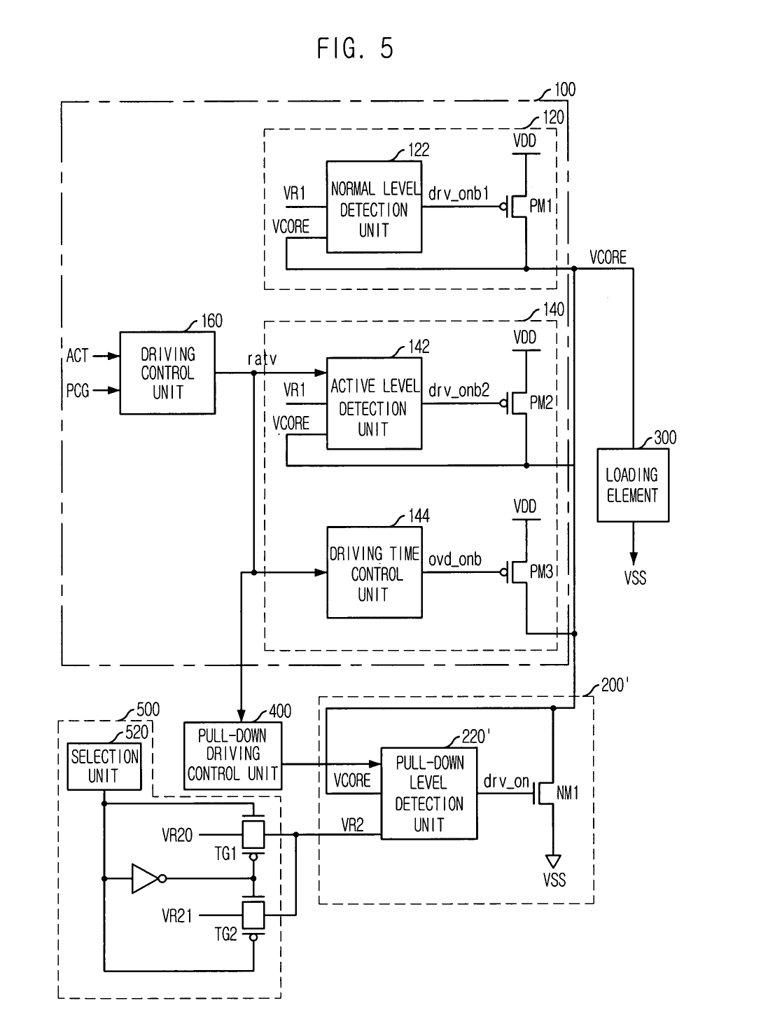

FIG. 5 is a block diagram showing an internal voltage generator in accordance with a second embodiment of the present invention.

As shown, the internal voltage generator includes an internal voltage generation unit 100 for generating an internal voltage VCORE according to a standby mode and an active mode to thereby control the internal voltage VCORE to be equal to or greater than a first reference voltage VR1; an internal voltage pull-down unit 200′ for pulling down a voltage level of the internal voltage VCORE to thereby control the internal voltage VR2 not to be greater than a second reference voltage VR2; a pull-down driving control unit 400 for controlling the internal voltage pull-down unit 200′; and a reference voltage generation unit 500 for generating the second reference voltage VR2. Herein, a voltage level of the second reference voltage VR2 is equal to or higher than a voltage level of the first reference voltage VR1.

Structures and operations of the internal voltage generation unit 100 and the internal voltage pull-down unit 200′ are similar to those of the internal voltage generation unit 100 and the internal voltage pull-down unit 200′ shown in FIG. 3. In comparison with the internal voltage generator shown in FIG. 3, the internal voltage generator shown in FIG. 5 further includes the pull-down driving control unit 400 and the reference voltage generation unit 500.

The pull-down driving control unit 400 controls the internal voltage pull-down unit 200′ to be enabled at the standby mode according to an active mode control signal ratv. That is, the pull-down driving control unit 400 activates the internal voltage pull-down unit 200′ at the standby mode and inactivates the internal voltage pull-down unit 200′ at the active mode. Therefore, a pull-down driver NM1 included in the internal voltage pull-down unit 200′ is turned on at the standby mode and is turned off at the active mode. Accordingly, a power consumption can be reduced.

The reference voltage generation unit 500 controls a voltage level of the second reference voltage VR2.

In detail, the reference voltage generation unit 500 includes a selection unit 520; a first transfer gate TG1; and a second transfer gate TG2.

The first transfer gate TG1 and the second transfer gate TG2 respectively receive a first voltage VR20 and a second voltage VR21. The selection unit 520 selectively turn on the first transfer gate TG1 and the second transfer gate TG2 to thereby output one of the first voltage VR20 and the second voltage VR21 as the second reference voltage VR2.

Therefore, in case that a semiconductor memory device includes a plurality of internal voltage generators, each internal voltage generator can appropriately adjust a voltage level of the second reference voltage VR2. For instance, if each bank included in the semiconductor memory device includes the internal voltage generator, the internal voltage generator can control the voltage level of the second reference voltage VR2.

As a result, as described above, the internal voltage generator in accordance with the present invention can prevent an internal voltage from being too much increased, and thus, the internal voltage can stay in a stable voltage level. Accordingly, a reliability of a semiconductor memory device can be increased and a physical damage of a circuit included in the semiconductor memory device can be prevented.

Meanwhile, although a driver for generating the internal voltage in accordance with the first and the second embodiment is embodied with a voltage level down converter, different-typed drivers can also be employed for the present invention.

The present application contains subject matter related to Korean patent application No. 2004-89326, filed in the Korean Patent Office on Nov. 4, 2004, the entire contents of which being incorporated herein by reference.

While the present invention has been described with respect to the particular embodiments, it will be apparent to those skilled in the art that various changes and modifications may be made without departing from the spirit and scope of the invention as defined in the following claims.

What is claimed is:

1. An internal voltage generator for use in a semiconductor memory device, comprising:
an internal voltage generation unit for generating the internal voltage according to a standby power mode and an active power mode based on a result of comparing the internal voltage with a first reference voltage; and
an internal voltage pull-down unit for controlling a voltage level of the internal voltage based on a result of comparing the internal voltage with a second reference voltage.

2. The internal voltage generator as recited in claim 1, wherein the internal voltage generation unit controls the internal voltage not to be lower than the first reference voltage.

3. The internal voltage generator as recited in claim 2, wherein the internal voltage pull-down unit decreases the internal voltage when the internal voltage is higher than the second reference voltage.

4. The internal voltage generator as recited in claim 3, wherein the second reference voltage is equal to or higher than the first reference voltage.

5. The internal voltage generator as recited in claim 4, wherein the internal voltage pull-down unit includes:
a pull-down level detector for generating a pull-down control signal according to the result of comparing the internal voltage with the second reference voltage; and
a pull-down driver for decreasing the voltage level of the internal voltage according to the pull-down control signal.

6. The internal voltage generator as recited in claim 5, wherein the pull-down level detector is a differential amplifier.

7. The internal voltage generator as recited in claim 5, wherein the pull-down driver is an n-type metal oxide semiconductor (NMOS) transistor, a drain of the NMOS transistor being coupled to the internal voltage and a source of the NMOS transistor being coupled to a ground voltage.

8. The internal voltage generator as recited in claim 4, wherein the internal voltage generation unit includes:
a normal driving unit for controlling the voltage level of the internal voltage based on the result of comparing the internal voltage with the first reference voltage both at the standby power mode and the active power mode;
an active mode driving unit for controlling the voltage level of the internal voltage in response to an active mode control signal based on the result of comparing the internal voltage with the first reference voltage at the active power mode; and
a driving control unit for generating the active mode control signal according to an active command and a precharge command.

9. The internal voltage generator as recited in claim 8, wherein the normal driving unit includes:
a normal level detection unit for comparing the internal voltage with the first reference voltage to thereby generate a normal driving control signal; and
a normal driver for controlling the voltage level of the internal voltage in response to the normal driving control signal.

10. The internal voltage generator as recited in claim 9, wherein the normal level detection unit is a differential amplifier.

11. The internal voltage generator as recited in claim 9, wherein the normal driver is a p-type metal oxide semiconductor (PMOS) transistor connected between a power supply voltage and the internal voltage, a gate of the PMOS transistor receiving the normal driving control signal.

12. The internal voltage generator as recited in claim 8, wherein the active mode driving unit includes:
an active level detection unit for comparing the internal voltage with the first reference voltage in response to the active mode control signal to thereby generate a first active driving control signal;
a first active mode driver for controlling the internal voltage according to the first active driving control signal;
a driving timing control signal for generating a second active driving control signal in response to the active mode control signal; and
a second active mode driver for controlling the internal voltage according to the second active driving control signal.

13. The internal voltage generator as recited in claim 12, wherein the active level detection unit is a differential amplifier.

14. The internal voltage generator as recited in claim 12, wherein the first active mode driver is a PMOS transistor connected between a power supply voltage and the internal voltage, a gate of the PMOS transistor receiving the first active driving control signal.

15. The internal voltage generator as recited in claim 12, wherein the second active mode driver is a PMOS transistor connected between a power supply voltage and the internal voltage, a gate of the PMOS transistor receiving the second active driving control signal.

16. An internal voltage generator for use in a semiconductor memory device, comprising:
an internal voltage generation unit for generating the internal voltage according to a standby power mode and an active power mode based on a result of comparing the internal voltage with a first reference voltage;
an internal voltage pull-down unit for controlling a voltage level of the internal voltage based on a result of comparing the internal voltage with a second reference voltage in response to a control signal; and
a pull-down control unit for generating the control signal to thereby adjust a voltage level of the second reference voltage and enable/disable the internal voltage pull-down unit according to the standby power mode and the active power mode.

17. The internal voltage generator as recited in claim 16, wherein the pull-down control unit enables the internal voltage pull-down unit at the standby mode and disables the internal voltage pull-down unit at the active mode.

18. The internal voltage generator as recited in claim 17, wherein the internal voltage generation unit controls the internal voltage not to be lower than the first reference voltage.

19. The internal voltage generator as recited in claim 18, wherein the internal voltage pull-down unit decreases the internal voltage when the internal voltage is higher than the second reference voltage.

20. The internal voltage generator as recited in claim 19, wherein the second reference voltage is equal to or higher than the first reference voltage.

21. The internal voltage generator as recited in claim 20, wherein the pull-down control unit includes:
a pull-down driving control unit for enabling/disabling the internal voltage pull-down unit according to the standby power mode and the active power mode; and
a reference voltage generation unit for adjusting the voltage level of the second reference voltage.
